(19) United States
(12) Patent Application Publication
(10) Pub. No.: US 2006/0103055 A1
(43) Pub. Date: May 18, 2006

(54) Polyolefin microporous membrane

(75) Inventors: Izumi Hoshuyama, Yokohama-shi (JP); Takahiko Kondo, Moriyama-shi (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(73) Assignee: Asahi Kasei Chemicals Corporation

(21) Appl. No.: 11/320,807

(22) Filed: Dec. 30, 2005

Related U.S. Application Data
(62) Division of application No. 09/646,512, filed on Sep. 18, 2000.

(30) Foreign Application Priority Data
Mar. 24, 1998 (JP) 10-093881
Apr. 27, 1998 (JP) 10-131011

(51) Int. Cl. B29C 55/00; H05B 6/00

(52) U.S. Cl. 264/479

(57) ABSTRACT

The present invention provides a polyolefin microporous membrane having a surface structure comprising fine spaces formed by partitioning micro-fibrils and a network formed by uniform dispersion of said micro-fibrils, wherein the average diameter of the micro-fibrils is 20 to 100 nm and the average distance between the micro-fibrils is 40 to 400 nm; and a process for producing said poly-olefin microporous membrane.

### TECHNICAL FIELD

The present invention relates to a polyolefin microporous membrane suitable as a battery separator used in various cylindrical batteries, rectangular batteries, thin batteries, button-shaped batteries, electrolytic capacitors, etc., and to a process for producing a polyolefin microporous membrane.

### BACKGROUND ART

Microporous membranes have been used as materials for filter media for water purifiers and the like, various separation membranes, air-permeable clothing, separators for batteries, and electrolytic capacitors, etc. In recent years, there is a growing demand for microporous membranes for use in secondary lithium-ion batteries, and separators for the batteries have become required to have high performance characteristics, with an increased energy density of the batteries.

Since an electrolytic solution and chemicals, such as positive- and negative-electrode active materials, are used in the secondary lithium-ion batteries, polyolefin type polymers are generally used as materials for the separators of the secondary batteries in view of chemical resistance. In particular, inexpensive polyethylenes and polypropylenes are used. The separators obtained by using such polymer materials are required to have various characteristics, such as electrode short-circuit-preventing function, ion permeability, electrode safety, etc. as basic performance characteristics.

The term “electrode short-circuit-preventing function” means that the separator fulfils the role of a diaphragm for preventing a short-circuit, by its presence between positive and negative electrodes. In a secondary battery, internal electrodes are expanded by charge and discharge, so that a pressure as high as several tens of kilograms per square centimeter is likely to be applied to the separator in some cases. Moreover, the surfaces of the electrodes are not always smooth and there is a fear that the separator may be injured because active material particles of various sizes become protruded or a stress is concentrated at the contact portion with an electrode tab. In order to prevent a short-circuit caused by such an injury, it is absolutely necessary for the separator to have a high-membrane strength. In addition, when the separator is used in a cylindrical battery or a thin battery, it is desired to have a high strength because a coil obtained by laminating and coiling the electrodes and the separator, is then compressed and cased.

The term “ion permeability” means the permeability of the separator only to ions and the electrolytic solution but not to active material particles. In general, the separator is required to have performance characteristics such as high porosity, low air permeability and low electric resistance, in order to reduce the ohmic loss and increase the discharge efficiency. However, the attainment of high ion permeability by resort to the prior art has been disadvantageous in that the membrane strength is decreased by an excessive increase in the porosity, and that the surface porous structure becomes nonuniform, so that the permeability becomes locally nonuniform, resulting in a decreased battery capacity in initial charge and discharge.

As another characteristic, the following shutdown function is important from the viewpoint of battery safety: when the battery generates heat to have an elevated temperature owing to trouble such as an external short-circuit or overcharge, the separator blocks up its pores by its thermal flow, thermal deformation, thermal shrinkage or the like, or forms an insulating film on the surface of each electrode, and thus shuts off an electric current automatically to stop the heat generation, preventing runaway or explosion of the battery. The shutdown function is most suitable when the separator exhibits the function at a lower temperature to shut off an electric current and maintains the shut-off state even at relatively high temperatures. Because of such performance characteristics required, materials composed mainly of a polyethylene resin are especially suitable as a material for the separator. In a microporous membrane for the separator, how to impart such various characteristics to the microporous membrane while maintaining a good balance among them, is an important technical issue.

JP-A-6-325747 discloses a polyethylene microporous membrane having a veiny structure comprising fine micro-fibrils and thick macro-fibrils composed of united micro-fibrils. The veiny-structure characteristic of said microporous membrane tends to be observed in a microporous membrane obtained by conducting only stretching after extraction (hereinafter referred to as post-extraction stretching), and the veiny structure is disadvantageous in that it becomes a nonuniform surface-porous structure, resulting in a nonuniform permeability. Moreover, the microporous membrane having said veiny structure is disadvantageous also in having a low membrane strength because a three-dimensional network comprising efficiently oriented micro-fibrils cannot be formed in said microporous membrane.

JP-A-7-228718 discloses a polyolefin microporous membrane having a dense structure comprising lamella crystals or micro-fibrils, which adhere to one another or are close to one another in the whole microporous membrane. The dense structure characteristic of this microporous membrane tends to be observed in a microporous membrane obtained by conducting only stretching before extraction (hereinafter referred to as pre-extraction stretching), and the dense structure is disadvantageous in that it is poor in permeability because the spaces among the micro-fibrils are too narrow.

JP-A-6-240036 discloses a polyolefin microporous membrane having a sharp pore-size distribution which is obtained by subjecting a gel-like composition to pre-extraction stretching and post-extraction stretching. This microporous membrane, however, is obtained by utilizing a solid-liquid phase-separation mechanism and hence undergoes the following phenomenon: the microporous membrane can have only a dense porous structure and hence has a low permeability, like the microporous membrane described in Comparative Example 2 given hereinafter, or the microporous membrane is increased in porosity to be greatly decreased in membrane strength. Thus, the membrane cannot have both a high membrane strength and a high permeability.

JP-A-1-101340 discloses a microporous membrane comprising a thermoplastic resin which is obtained by utilizing a liquid-liquid phase separation mechanism. This microporous membrane is obtained by conducting post-extraction stretching and has an improved permeability. This microporous membrane, however, is disadvantageous in that a veiny structure comprising a large number of thick macro-fibrils, is observed in the surface structure of the microporous membrane, resulting in a nonuniform permeability, as in the case of the microporous membranes obtained by processes similar to that for said microporous membrane which are described in Comparative Examples 3 and 4 given hereinafter. Said microporous membrane is disadvantageous also in having a low membrane strength.

JP-A-2-88649 discloses a polypropylene microporous membrane having a structure comprising thick macro-fibrils perpendicular to the direction of stretching, thin micro-fibrils parallel to the direction of stretching, and slit-like pores among the micro-fibrils. Such a slit-like pore structure characteristic of this microporous membrane tends to be observed in a microporous membrane produced by a so-called lamella-stretching hole-making method, and cannot give an effective permeability in proportion to the pore volume because of the slender shape of the pores. Furthermore, because of the presence of the thick macro-fibrils in a large number, the surface porous structure is not uniform, resulting in a nonuniform permeability. The microporous membrane disclosed in the above reference also involves a problem of low membrane strength.

### DISCLOSURE OF THE INVENTION

The present invention is intended to provide a microporous membrane that can retain a high permeability without decreasing in the membrane strength and has a highly uniform surface porous structure free from local nonuniformity of the permeability.

The present inventors earnestly investigated in order to solve the above problems, and consequently found that a microporous membrane which is free from local nonuniformity of the permeability so as to prevent the occurrence of battery failures such as a decrease in battery capacity in initial charge and discharge and which is well balanced between permeability and membrane strength, can be provided by employing a surface structure comprising highly dispersed micro-fibrils as the porous structure of the microporous membrane. Thus, the present invention has been accomplished.

That is, the first aspect of the present invention is directed to a polyolefin microporous membrane having a surface structure comprising fine spaces formed by partitioning micro-fibrils and a network formed by uniform dispersion of said micro-fibrils, wherein the average diameter of the micro-fibrils is 20 to 100 nm and the average distance between micro-fibrils is 40 to 400 nm. The micro-fibril space gradient is preferably 0.10 to 0.90 in the cross-section structure of the polyolefin microporous membrane. More preferably, the above-mentioned polyolefin microporous membrane comprises a polyethylene resin.

The second aspect of the present invention is directed to a process for producing a polyolefin microporous membrane which comprises:

(a) a step of melt-kneading a composition consisting of a polyolefin resin and a solvent which has a thermally induced liquid-liquid phase-separation point when mixed with said polyolefin resin, to effect uniform dispersion, and then solidifying the resulting dispersion by cooling to form a sheet-like material comprising layers composed of a percolation structure and a layer composed of a cell structure;

(b) a step of conducting at least one run of stretching at least uniaxially after the above step (a);

(c) a step of removing a substantial portion of the aforesaid solvent after the above step (b); and

(d) a step of conducting at least one run of stretching at least uniaxially after the above step (c).

In the above process, the aforesaid polyolefin resin is preferably a polyethylene resin.

The third aspect of the present invention is directed to a polyolefin microporous membrane obtained by a production process according to the second aspect of the present invention.

The fourth aspect of the present invention is directed to a separator for battery which comprises a polyolefin microporous membrane according to the first or third aspect of the present invention.

### BRIEF DESCRIPTION OF DRAWINGS

FIG. 1 is a graph showing a kneading torque characteristic of a composition, which is used in the present invention, having a thermally induced liquid-liquid phase-separation point.

FIG. 2 is a graph showing a kneading torque characteristic of a composition, which is different from that used in the present invention, having no thermally induced liquid-liquid phase-separation point.

FIG. 3 is a photograph taken through a scanning electron microscope (SEM, 2,000 magnifications) that shows a cross-section structure of a sheet-like material according to the present invention, which comprises layers composed of a percolation structure, and a layer composed of a cell structure. In FIG. 3, the downward direction corresponds to the direction of the surface layer of the sheet, and the upward direction to the internal layer of the sheet.

FIG. 4 is a photograph taken through a scanning electron microscope (SEM, 10,000 magnifications) of the percolation structure in the cross-section of the sheet-like material according to the present invention.

FIG. 5 is a photograph taken through a scanning electron microscope (10,000 magnifications) of the surface structure of the microporous membrane obtained in Example 2 of the present invention.

FIG. 6 is a photograph taken through a scanning electron microscope (30,000 magnifications) of the surface structure of the microporous membrane obtained in Example 2 of the present invention.

FIG. 7 is a photograph taken through a scanning electron microscope (10,000 magnifications) of the cross-section of the microporous membrane obtained in Example 2 of the present invention. In FIG. 7, the upward direction corresponds to the direction of the surface layer portion of the microporous membrane, and the downward direction to the internal layer portion.

FIG. 8 is a photograph taken through a scanning electron microscope (10,000 magnifications) of the surface structure of the microporous membrane obtained in Comparative Example 1 given hereinafter.

FIG. 9 is a photograph taken through a scanning electron microscope (30,000 magnifications) of the surface structure of the microporous membrane obtained in Comparative Example 1 given hereinafter.

FIG. 10 is a photograph taken through a scanning electron microscope (10,000 magnifications) of the cross-section of the microporous membrane obtained in Comparative Example 1 given hereinafter. In FIG. 10, the upward direction corresponds to the direction of the surface layer portion of the microporous membrane, and the downward direction to the internal layer portion.

FIG. 11 is a photograph taken through a scanning electron microscope (30,000 magnifications) of the surface structure of the microporous membrane obtained in Comparative Example 2 given hereinafter.

FIG. 12 is a photograph taken through a scanning electron microscope (10,000 magnifications) of the cross-section of the microporous membrane obtained in Comparative Example 2 given hereinafter. In FIG. 12, the upward direction corresponds to the direction of the surface layer portion of the microporous membrane, and the downward direction to the internal layer portion.

FIG. 13 is a photograph taken through a scanning electron microscope (10,000 magnifications) of the surface structure of the microporous membrane obtained in Comparative Example 4 given hereinafter.

### BEST MODE FOR CARRYING OUT THE INVENTION

The microporous membrane of the present invention is in the form of a porous sheet or film comprising a polyolefin resin.

The first feature of the surface structure of the microporous membrane of the present invention is that the surface structure comprises fine spaces formed by partitioning micro-fibrils (hereinafter referred to as micro-fibril spaces).

The micro-fibril is a fine continuous structure observed in a highly oriented microporous membrane obtained by stretching and has a string form, a fiber form or the like.

The space refers to a fine empty space, formed by partitioning by said micro-fibrils, which is substantially circular or polygonal with inclination toward a circle. For attaining a good permeability, it is preferable that the shape of said spaces be substantially circular or polygonal with inclination toward a circle.

The second feature of the surface structure of the microporous membrane of the present invention is that the surface structure comprises a network comprising uniformly dispersed micro-fibrils. In the present invention, the micro-fibrils do not substantially adhere to one another but form a three-dimensional network by criss-crossing, interconnecting or branching while forming spaces among themselves. When said micro-fibrils form a so-called macro-fibril by adhesion and union of several or tens of them, a veiny structure like that disclosed in JP-A-6-325747 is formed. The veiny structure is a nonuniform structure that tends to be observed in a microporous membrane obtained by conducting only post-extraction stretching. The veiny structure is not desirable because its macro-fibril portions cannot contribute to the permeability and this structure is poor in pore uniformity, resulting in local nonuniform permeability. Therefore, it is important that the surface structure of the microporous membrane of the present invention should not substantially contain macro-fibrils having a thickness of preferably 1000 nm or more, more preferably 500 nm or more, most preferably 300 nm or more. On the other hand, as disclosed in JP-A-7-228718, a structure comprising the micro-fibrils that adhere to one another or are close to one another in the whole microporous membrane, is a dense structure that tends to be observed in a microporous membrane obtained by conducting only pre-extraction stretching. Said structure is not desirable because, although it has high pore uniformity, it has poor in permeability due to too narrow spaces among the micro-fibrils.

In the microporous membrane of the present invention, the average diameter of micro-fibrils, determined by the method described hereinafter, should be 20 to 100 nm, preferably 30 to 80 nm, more preferably 40 to 70 nm. When the average diameter of micro-fibrils is more than 100 nm, the proportion of macro-fibrils formed by the union of the micro-fibrils is apt to be undesirably increased, resulting in a low pore uniformity. On the other hand, when the average micro-fibril diameter is less than 20 nm, there is a fear that the strength or stiffness of a matrix forming the network may be decreased.

In the microporous membrane of the present invention, the average distance between micro-fibrils, determined by the method described hereinafter, refers to the average size of spaces formed by the partitions of micro-fibrils, and is 40 to 400 nm, preferably 45 to 100 nm, more preferably 50 to 80 nm. When the average distance between micro-fibrils is more than 400 nm, the function of preventing the permeation of fine particles of electrode-active materials and the like, is deteriorated, which is undesirable. On the other hand, when the average distance between micro-fibrils is less than 40 nm, the permeability is undesirably low.

The micro-fibril space density of the microporous membrane of the present invention, refers to the average number of micro-fibril spaces per unit area in the surface structure of the microporous membrane, and is preferably 10 to 100 spaces/μm², more preferably 20 to 80 spaces/μm², most preferably 25 to 60 spaces/μm². When the micro-fibril space density is more than 100 spaces/μm², the spaces among the micro-fibrils are apt to become undesirably narrow, resulting in a low permeability. On the other hand, when the micro-fibril space density is less than 10 spaces/μm², the spaces among the micro-fibrils become too wide or the microporous membrane is poor in pore uniformity, which is undesirable. The micro-fibril space density is determined by the method described hereinafter.

In the cross-section structure of the microporous membrane of the present invention, the micro-fibril space gradient determined by the method described hereinafter refers to the ratio of the porosity of the surface layer portion to the porosity of the internal layer portion, and is preferably 0.10 to 0.90, more preferably 0.20 to 0.80, most preferably 0.30 to 0.60. When the micro-fibril space gradient is 0.90 or less, the porous structure of the internal layer portion becomes coarser than the porous structure of the surface layer portion in the cross-section structure of the microporous membrane. It is more preferable to employ a gradient structure that becomes coarser gradually from the surface layer portion to the internal layer portion with a decrease of the distance from innermost of the microporous membrane. That the porous structure of the internal layer portion is coarser than the porous structure of the surface layer portion means that the area occupied by micro-fibril spaces in the internal layer portion is larger than the area occupied by micro-fibril spaces in the surface layer portion in a cross-section of the microporous membrane. Such a cross-section structure as observed in the microporous membrane of the present invention can be obtained by giving a cross-section structure comprising a cell structure and a percolation structure which are formed through a thermally induced liquid-liquid phase separation mechanism, to a sheet-like material in the production process of the present invention. When the micro-fibril space gradient is more than 0.90, the porous structures of the internal layer portion and the surface layer portion have the same denseness, or the porous structure of the internal layer portion becomes denser than the porous structure of the surface layer portion. When the microporous membrane is used as a battery separator, the internal layer portion is preferably coarse for the following reason: when the internal layer portion is coarse, an electrolytic solution can be held inside the microporous membrane and hence it is not eliminated even if a pressure is applied to the separator by the expansion of electrodes caused by repeated charging and discharging of the battery, and thus trouble such as a decrease in efficiency of the charge and discharge can be prevented. However, when the micro-fibril space gradient is less than 0.10, the surface layer portion becomes too dense, resulting in a low permeability, or the internal layer portion becomes too coarse, resulting in a low membrane strength.

The cross-section structure of the microporous membrane of the present invention is preferably composed of a network comprising highly oriented micro-fibrils. Such a cross-section structure permits attainment of both high membrane strength and satisfactory permeability.

The thickness of the microporous membrane of the present invention is preferably 1 to 500 μm, more preferably 10 to 100 μm. When the thickness is less than 1 μm, the membrane strength becomes insufficient. When the thickness is more than 500 μm, the volume occupied by the separator is undesirably increased, resulting in a disadvantage in increasing the capacity of the battery.

The air permeability of the microporous membrane of the present invention is preferably 1 to 3,000 sec/25 μm, more preferably 10 to 1,000 sec/25 μm, still more preferably 50 to 500 sec/25 μm, and most preferably 50 to 400 sec/25 μm. The air permeability is defined as the ratio of air permeation time to the membrane thickness. When the air permeability is more than 3,000 sec/25 μm, the ion permeability is low or the pore size is very small, which is not desirable in either case for the overall permeability of the microporous membrane.

The porosity of the microporous membrane of the present invention is preferably 20 to 70%, more preferably 30 to 65%, most preferably 35 to 60%. When the porosity is less than 20%, the air permeability and the ion permeability represented by electrical resistance become undesirably insufficient. When the porosity is more than 70%, the membrane strength represented by penetration strength and the like becomes undesirably insufficient.

The penetration strength of the microporous membrane of the present invention is preferably 300 to 2,000 gf/25 μm, more preferably 350 to 1,500 gf/25 μm, most preferably 400 to 1,000 gf/25 μm. The penetration strength is defined as the ratio of the maximum load to the membrane thickness in a penetration test. When the penetration strength is less than 300 gf/25 μm, defects such as short-circuit are undesirably increased in the production of a battery by coiling. When the penetration strength is more than 2,000 gf/25 μm, there is no particular disadvantage but it is difficult to produce such a microporous membrane in practice.

The polyolefin resin used in the present invention includes olefin polymers and copolymers used in conventional extrusion, injection, inflation, and blow molding. As the polyolefin resin, there can be used homopolymers and copolymers of ethylene, propylene, 1-butene, 4-methyl-1-penetene, 1-hexene, 1-octene, etc. Mixtures of polyolefin resins selected from the group consisting of these homopolymers and copolymers can also be used. Typical examples of the above-exemplified polymers are low-density polyethylenes, linear low-density polyethylenes, medium-density polyethylenes, high-density polyethylenes, ultra-high-molecular-weight polyethylenes, ethylene propylene rubber, isotactic polypropylenes, atactic polypropylenes, poly(1-butene)s, poly(4-methyl-1-pentene)s, etc. When the microporous membrane of the present invention is used as a separator for battery, it is preferable to use a resin composed mainly of a polyethylene, more preferably a resin composed mainly of a high-density polyethylene, because such a resin is a low-melting resin and gives a high strength as a required property.

The average molecular weight of the polyolefin resin used in the present invention is preferably less than 5,000,000 but not less than 50,000, more preferably less than 700,000 but not less than 100,000, most preferably less than 500,000 but not less than 200,000. Said average molecular weight refers to the weight average molecular weight determined by GPC (gel permeation chromatography) measurement or the like. In general, in the case of a resin having an average molecular weight of more than 1,000,000, its accurate average molecular weight is difficult to determine by GPC measurement, and hence its viscosity average molecular weight determined by a viscometric method may be employed in place of the accurate average molecular weight. When the average molecular weight is less than 50,000, the melt viscosity is undesirably lost in melt shaping, so that the moldability is deteriorated or that the stretchability is deteriorated, resulting in a low strength. When the average molecular weight is more than 5,000,000, the preparation of a homogeneous melt-kneaded product is apt to be undesirably difficult.

The molecular weight distribution of the polyolefin resin used in the present invention is preferably less than 30 but not less than 1, more preferably less than 9 but not less than 2, most preferably less than 8 but not less than 3. The molecular weight distribution is expressed as the ratio between the weight average molecular weight (Mw) and number average molecular weight (Mn) determined by GPC measurement (Mw/Mn). When the molecular weight distribution is 30 or more, there is an undesirable fear of decrease in the membrane strength and an undesirable influence on the dispersion of micro-fibrils.

It is absolutely necessary for a solvent used in the present invention to have a thermally induced liquid-liquid phase separation point when mixed with the polyolefin resin. When the solvent has the thermally induced liquid-liquid phase-separation point, a composition consisting of the polyolefin resin and the solvent undergoes thermally induced liquid-liquid phase separation at a temperature not lower than the crystallization temperature of the resin when it is cooled after being melt-kneaded to form a homogeneous solution. As the solvent, it is preferable to use a nonvolatile solvent capable of forming the homogeneous solution at a temperature not lower than the crystallization temperature of the resin. The form of the solvent may be either an ordinary-temperature liquid or an ordinary-temperature solid. When the solvent has no thermally induced liquid-liquid phase-separation point when mixed with the polyolefin resin, it becomes difficult to obtain a microporous membrane sufficient in both permeability and strength.

The solvent includes, for example, phthalic acid esters such as di(2-ethylhexyl) phthalate (DOP), diisodecyl phthalate (DIDP), dibutyl phthalate (DBP), etc.; sebacic acid esters such as dibutyl sebacate (DBS), etc.; adipic acid esters such as di(2-ethylhexyl) adipate (DOA), etc.; phosphoric esters such as trioctyl phosphate (TOP), tricresyl phosphate (TCP), tributyl phosphate (TBP), etc.; trimellitic acid esters such as trioctyl trimellitate (TOTM), etc.; oleic acid esters; stearic acid esters; and tallow amines.

The thermally induced liquid-liquid phase separation point characteristic of the solvent used in the present invention is present at a temperature not lower than the crystallization temperature Tc° C. of the polyolef in resin, and is preferably in a range of (Tc+20)° C. to 250° C., more preferably (Tc+20)° C. to 200° C. When said phase separation point is lower than Tc° C., no liquid-liquid phase separation takes place. In this case, a sheet-like material due to liquid-liquid phase separation, i.e., a sheet-like material comprising a relatively coarse layer composed of a cell structure and relatively dense layers composed of a percolation structure, cannot be obtained, and an entirely homogeneous and dense spherulite-assembly structure is formed as the resulting layer. Therefore, no microporous membrane with well-balanced membrane strength and permeability can be obtained.

The first method for measuring the thermally induced liquid-liquid phase separation point comprises preparing a specimen of kneaded material consisting of the polyolefin resin and the solvent by melt-kneading them in predetermined proportions, placing the specimen on a hot plate, and observing the difference in depth of shade between a concentrated phase and a dilute phase at the time of liquid-liquid phase separation using a phase-contrast microscope while cooling the specimen from a high temperature at a predetermined cooling rate. According to this method, the thermally induced liquid-liquid phase separation point can be observed as a temperature at which the amount of transmitted light changes rapidly in the cooling process. In addition, when the magnification of the microscope is sufficiently high or the size of drops of the dilute phase produced by the liquid-liquid phase separation is sufficiently large, the drops can be visually confirmed, so that the thermally induced liquid-liquid phase separation point can be observed as a temperature at which the drops are formed.

The second method for measuring the thermally induced liquid-liquid phase separation point comprises melt-kneading a composition consisting of the polyolefin resin and the solvent in predetermined proportions at a sufficient temperature for a sufficient time to obtain a homogeneous solution, placing the resulting kneaded material in a container such as a test tube, allowing the container to stand in a thermostat maintained constant at a predetermined temperature, and observing a temperature at which nonequilibrium two-phase separation takes place statically.

The third method for measuring the thermally induced liquid-liquid phase separation point comprises melt-kneading a composition consisting of the polyolefin resin and the solvent in predetermined proportions, at a sufficient temperature for a sufficient time to obtain a homogeneous solution using a simple screw kneading apparatus such as Brabender or a mill, cooling the kneaded composition while continuing the screw kneading, and observing a change of kneading torque. According to this method, the thermally induced liquid-liquid phase separation point can be observed as a temperature at which the kneading torque decreases rapidly during the cooling process. As to the degree of decrease in the kneading torque, investigation by the present inventor(s) has revealed that a temperature at which the kneading torque decreases by about 20% or more relative to a torque value before the decrease may be regarded as the liquid-liquid phase separation point. The absolute value of the kneading torque, however, is not important here because it is affected by the resin viscosity, the solvent viscosity, the polymer concentration, and the degree of packing of the kneaded material in a kneading vessel.

As the proportions of the polyolefin resin and solvent used in the present invention, any proportions may be employed so long as the resulting composition has a thermally induced liquid-liquid phase separation point and the proportions permit preparation of a homogeneous solution at a kneading temperature employable in practice and are sufficient to form a sheet-like material. Specifically, the weight proportion of the polyolefin resin is preferably 20 to 70%, more preferably 30 to 60%, based on the weight of a composition consisting of the polyolefin resin and the solvent. When the weight proportion of the polyolefin resin is less than 20%, the membrane strength is undesirably decreased. On the other hand, when the weight fraction of the polyolefin resin is more than 70%, the preparation of a sheet-like material having a porous structure tends to become difficult, resulting in a low permeability.

Examples of the composition consisting of the solvent and the polyolefin resin and having a thermally induced liquid-liquid phase-separation point, are compositions consisting of 1 to 75% of a polyethylene resin and 25 to 99% of dibutyl phthalate, compositions consisting of 1 to 55% of a polyethylene resin and 45 to 99% of di(2-ethylhexyl) phthalate, compositions consisting of 1 to 50% of a polyethylene resin and 50 to 99% of diisodecyl phthalate, compositions consisting of 1 to 45% of a polyethylene resin and 50 to 99% of dibutyl sebacate, etc.

As an extraction solvent used in the present invention, there is used a solvent which is a poor solvent for the polyolefin resin, but a good solvent for the solvent and has a boiling point lower than the melting point of the microporous membrane. Such an extraction solvent includes, for example, hydrocarbons such as n-hexane, cyclohexane, etc.; halogenated hydrocarbons such as methylene chloride, 1,1,1-trichloroethane, etc.; alcohols such as ethanol, isopropanol, etc.; ethers such as diethyl ether, tetrahydrofuran, etc.; and ketones such as acetone, 2-butanone, etc. In addition, of the solvents exemplified above, the alcohols and the ketones are suitable in view of adaptability to environment, safety and hygienic properties.

The microporous membrane of the present invention is produced by melt-kneading a composition consisting of the polyolefin resin and the solvent and having a thermally induced liquid-liquid phase separation point when mixed with the polyolefin resin, solidifying the melt-kneaded composition by cooling to form a sheet-like material, subjecting the sheet-like material to at least one run of pre-extraction stretching at least uniaxially, removing substantial portion of the solvent, and then subjecting thus-treated sheet-like material to at least one run of post-extraction stretching at least uniaxially. The product thus obtained can be subjected to heat treatment, such as thermal fixation or thermal relaxation.

In the present invention, the first method for melt-kneading the polyolefin resin and the solvent comprises feeding the polyolefin resin into a continuous resin-kneading apparatus such as an extruder, introducing the solvent thereinto in any proportion while heating and melting said resin, and then kneading the resulting composition consisting of the resin and the solvent to obtain a homogeneous solution. The form of the polyolefin resin used can be any of powder, granules and pellets. When the melt kneading is conducted by such a method, the form of the solvent is preferably an ordinary-temperature liquid. As the extruder, there can be used a single-screw extruder, a twin-screw extruder using screws capable of rotating in different directions, a twin-screw extruder using screws capable of rotating in the same direction, etc.

The second method for melt-kneading the polyolefin resin and the solvent comprises mixing the resin and the solvent at ordinary temperature in advance to effect dispersion, feeding the resulting mixed composition into a continuous resin-kneading apparatus such as an extruder, and then kneading the mixed composition to obtain a homogeneous solution. The form of the mixed composition to be fed may be a slurry if the solvent is an ordinary-temperature liquid. It may be powder or the like if the solvent is an ordinary-temperature solid.

In both of the above-mentioned first and second methods for the melt kneading, it is important to knead the polyolefin resin and the solvent in a continuous-kneading apparatus such as an extruder, to obtain a homogeneous solution, and such kneading can improve the productivity.

The third method for melt-kneading the polyolefin resin and the solvent is a method using a simple resin-kneading apparatus such as Brabender or a mill, or a method of conducting the melt kneading in another batch-type kneading vessel. This method is advantageous, being simple and highly flexible, though it is not satisfactory in productivity because of its batch procedure.

In the present invention, the first method for obtaining the sheet-like material by solidifying the melt-kneaded composition by cooling, comprises extruding a homogeneous solution, consisting of the polyolefin resin and the solvent, into a sheet through a T-die or the like, and bringing the sheet into contact with a heat conductor to cool the same to a temperature sufficiently lower than the crystallization temperature of the resin. As the heat conductor, a metal, water, air or the solvent itself can be used, though a method comprising bringing the sheet into contact with one or more metal rolls to cool the sheet is especially preferable because it has the highest heat-conduction efficiency. When the sheet is brought into contact with metal rolls, it is preferable to calender or hot-roll the sheet by holding the sheet between the rolls because such a treatment improves not only the heat-conduction efficiency but also the surface smoothness of the sheet.

The second method for obtaining the sheet-like material comprises extruding a homogeneous solution, consisting of the polyolefin resin and the solvent, into a cylinder through a circular die or the like, cooling the extruded product to solidify the same, for example, by pulling it into a cooling-medium bath and/or introducing a cooling medium into the cylindrical extruded product, and then processing the solidified product into a sheet.

A method for giving a cross-section structure comprising layers composed of a percolation structure and a layer composed of a cell structure, to the sheet-like material prepared in the present invention, comprises solidifying the sheet-like material by cooling at a cooling rate of preferably 100° C./min or more, more preferably 200° C./min or more, from at least one side of the sheet-like material. The cooling rate is measured by embedding a thermocouple or the detecting end of a temperature sensor in the interior of the sheet-like material. A percolation structure formed in initial spinodal decomposition is instantly fixed in the surface layer portion where the cooling rate is relatively rapid, and a cell structure formed as a result of shift toward cluster transfer is fixed in the internal layer portion where the cooling rate is relatively slow. Thus, a sheet-like material comprising both structures can be obtained.

As other methods, there are, for example, a method comprising producing a sheet-like material composed of a percolation structure and a sheet-like material composed of a cell structure, separately from each other, and laminating them before or after any of a pre-extraction stretching step, an extraction step and a post-extraction stretching step, and a method comprising laminating sheet-like materials obtained using solvents different in miscibility, followed by extrusion.

In the cross-section structure of the sheet-like material, the proportion of the layers composed of a percolation structure to the layer composed of a cell structure is preferably 1 to 99% of the former to 99 to 1% of the latter, more preferably 2 to 50% of the former to the 98 to 50% of the latter. A microporous membrane obtained from a sheet-like material containing no internal layer composed of a cell structure is not desirable because it has a poor ability to hold an electrolytic solution therein.

The cell structure observed in the sheet-like material obtained in the present invention refers to a honeycomb-like or spongy structure composed of cellular, void-like or hollow, empty spaces having a substantially spherical shape and a diameter of about 0.5 to about 10 μm, and three-dimensionally continuous polymer-rich partitions formed so as to isolate adjacent empty spaces from each other or to intercommunicate them with each other through only very fine holes having a diameter of less than about 0.5 μm.

The percolation structure observed in the sheet-like material obtained in the present invention refers to a structure composed of passageway-like pores with a diameter of about 0.1 to about 1 μm extending so as to be intertwined with one another three-dimensionally and randomly, and a polymer network formed by three-dimensional and random connection of polymer fibers, strings, branches or rods having a diameter of about 0.1 to about 1 μm.

In the present invention, the first method for extracting the solvent comprises cutting the microporous membrane to predetermined dimensions, immersing the microporous membrane in an extraction solvent in a vessel to wash the same thoroughly, and then air-drying the adhering solvent with air at room temperature or with hot air. In this case, it is preferable to repeat immersing operation and washing operation many times because the repetition reduces the amount of the residual solvent in the microporous membrane. In addition, each edge of the microporous membrane is preferably fastened for preventing the shrinkage of the microporous membrane during a series of the steps, i.e., immersing, washing and drying.

The second method for extracting the solvent comprises continuously introducing the microporous membrane into a bath filled with an extraction solvent, immersing the microporous membrane in the extraction solvent for a sufficient period of time to remove the solvent, and then drying the adhering solvent. In this case, the following well-known means is preferably employed because it can improve the extraction efficiency: a multi-stage method in which the interior of the bath is divided into multiple portions and the microporous membrane is introduced successively into the portions different in concentration, or a countercurrent method for giving a concentration gradient by supplying the extraction solvent from a direction opposite to the traveling direction of the microporous membrane. In both of the above-mentioned first and second methods for extracting the solvent, substantial removal of the solvent from the microporous membrane is important. Heating the extraction solvent at a temperature lower than its boiling point is more preferable because it can accelerate the diffusion of the solvents and hence can increase the extraction efficiency.

In the present invention, stretching conducted before the extraction step is called pre-extraction stretching, and as this stretching, it is absolutely necessary to carry out at least one run of stretching operation at least uniaxially. The term “at least uniaxially” means any of uniaxial stretching in direction of machine, uniaxial stretching in width direction, simultaneous biaxial stretching and successive biaxial stretching. The term “at least one run” means any of one-stage stretching, multi-stage stretching and many runs of stretching. Since the pre-extraction stretching in the present invention is conducted with the solvent being highly dispersed in the micropores, spaces in crystals, and noncrystalline portion of the microporous membrane, the plasticizing effect improves the stretchability and moreover, an inhibitory effect on the increase of the porosity of the microporous membrane can be obtained. Thus, stretching at a high ratio can be achieved, so that a high strength can be attained. For attaining a still higher strength, biaxial stretching is preferable, and simultaneous biaxial stretching is the most preferable because it can simplify the process. When the melting point of the microporous membrane is taken as Tm° C., the stretching temperature is preferably lower than Tm° C. and not lower than (Tm−50)° C., more preferably lower than (Tm−5)° C. and not lower than (Tm−40)° C. When the stretching temperature is lower than (Tm−50)° C., deterioration of the stretchability, remaining of a strain component after the stretching, and deterioration of the high-temperature dimensional stability are undesirably caused. When the stretching temperature is Tm° C. or higher, the microporous membrane is undesirably melted to be deteriorated in permeability. Although the draw ratio can be set at any ratio, it is preferably 4 to 20, more preferably 5 to 10, in the case of uniaxial stretching, and it is preferably 4 to 400, more preferably 5 to 100, most preferably 30 to 100, in terms of area ratio in the case of biaxial stretching.

In the present invention, stretching conducted after the extraction step is called post-extraction stretching, and is employed together with the above-mentioned pre-extraction stretching. As the post-extraction stretching, it is absolutely necessary to carry out at least one run of stretching at least uniaxially. Since the post-extraction stretching is conducted after substantial removal of the solvent from the microporous membrane, the destruction of the polymer interface dominantly accompanies the stretching, so that the post-extraction stretching has the effect of increasing the porosity of the microporous membrane. Therefore, if only the post-extraction stretching is conducted without the pre-extraction stretching, the porosity is excessively increased in vain and, undesirably, no orientation is imparted to the microporous membrane, resulting in low strength. By contrast, when the pre-extraction stretching and the post-extraction stretching are employed in combination, the porosity can be increased without decreasing the strength of the microporous membrane. When the melting point of the microporous membrane is taken as Tm° C., the stretching temperature is preferably lower than Tm° C. and not lower than (Tm−50)° C., more preferably lower than (Tm−5)° C. and not lower than (Tm−40)° C. When the stretching temperature is lower than (Tm−50)° C., deterioration of the stretchability, remaining of a strain component after the stretching, and deterioration of the high-temperature dimensional stability are undesirably caused. When the stretching temperature is Tm° C. or higher, the microporous membrane is undesirably melted to be deteriorated in permeability. Although the draw ratio can be set at any ratio, it is preferably 1.1 to 5, more preferably 1.2 to 3, in the case of uniaxial stretching, and it is preferably 1.1 to 25, more preferably 1.4 to 9, in terms of area ratio in the case of biaxial stretching.

In the present invention, heat treatment is preferably carried out immediately or some time after the final stretching step. The heat treatment refers to either thermal fixation or thermal relaxation. The term “thermal fixation” means a heat treatment which is carried out while maintaining the draw ratio set at the time of stretching or while allowing the membrane to assume a stretched state by still fastening the membrane. By contrast, the term “thermal relaxation” means a heat treatment which is carried out at a relaxed state. Both the thermal fixation and the thermal relaxation remove residual stress and strain which are considered to be produced during stretching, to improve the high-temperature dimensional stability, and moreover they also have a function of properly controlling the permeability represented by porosity and air permeability. In the first mode for carrying out the heat treatment, the heat treatment is carried out continuously and subsequently to the stretching step. For example, there is a method comprising conducting stretching with a uniaxial or biaxial stretching machine such as a tenter, and then carrying out the heat treatment for a predetermined period of time while maintaining the maximum draw ratio set at the time of the stretching or while relaxing the membrane by setting the ratio smaller than the set maximum draw ratio. In the second mode for carrying out the heat treatment, the heat treatment is intermittently carried out after the stretching. For example, there is a method comprising conducting stretching with a test biaxial stretching machine such as a stretcher, and then carrying out the heat treatment for a predetermined period of time by fastening the microporous membrane again, or carrying out the heat treatment while relaxing the membrane by setting the ratio smaller than the draw ratio set at the time of the stretching.

As described hereinafter, the term “relaxation rate” used herein means the rate of thermal relaxation set in the heat treatment step, and is preferably 1 to 50%, more preferably 10 to 40%. When the relaxation rate is less than 1%, in particular, when it is 0%, the heat treatment is called thermal fixation herein. In this case, the high-temperature dimensional stability of the microporous membrane tends to be relatively deteriorated, so that the heat treatment should be carried out for a long period of time, resulting in a low production efficiency. When the relaxation rate is more than 50%, wrinkling or membrane thickness distribution is undesirably caused.

In the present invention, after-treatment may be carried out so long as it does not offset the advantages obtained by the present invention. The after-treatment includes, for example, hydrophilicity-imparting treatment using a surfactant or the like, and crosslinking treatment using ionizing radiation or the like.

Additives such as antioxidants, nucleating agents, antistatic agents, flame retardants, lubricants, ultraviolet absorbers and the like, may be incorporated into the composition used in the present invention, depending on purposes.

The present invention is explained below in further detail with examples.

The test methods described in the examples are as follows.

(1) Membrane Thickness

Measured with a dial gauge (PEACOCK NO. 25, mfd. by Ozaki Seisaku-sho Co., Ltd.).

(2) Porosity

A specimen 20 cm square was cut out of a microporous membrane and its volume (cm³) and weight (g) were measured. From the results obtained, porosity (%) was calculated by the following equation:

$$Porosity = 100 \times ( 1 - weight \div ( density of resin \times volume ) )$$

(3) Air Permeability

On the basis of air permeation time (sec/100 cc) measured with a Gurley densometer according to JIS P-8117 and membrane thickness (μm), conversion using the membrane thickness was carried out according to the following equation to determine air permeability (sec/100 cc/25 μm):

Air permeability=air permeation time×25÷membrane thickness

(4) Penetration Strength

Using a compression tester KES-G5 manufactured by Kato Tec Co., Ltd., a penetration test was carried out under the following test conditions: radius of curvature of a needle top 0.5 mm, penetration speed 2 mm/sec, measuring temperature 23±2° C. On the basis of the maximum penetration load (gf) and membrane thickness (μm), conversion using the membrane thickness was carried out according to the following equation to determine penetration strength (gf/25 μm):

Penetration strength=maximum penetration load×25÷membrane thickness

(5) Average Molecular Weight and Molecular Weight Distribution

Weight average molecular weight (Mw) and number average molecular weight (Mn) were determined by carrying out GPC (gel permeation chromatography) measurement under the conditions described below, and average molecular weight was taken as Mw and molecular distribution was taken as Mw/Mn:

Instrument: WATERS 150-GPC

Temperature: 140° C.

Solvent: 1,2,4-trichlorobenzene

Concentration: 0.05% (injecting amount: 500 μl)

Columns: a column of Shodex GPC AT-807/S, and two columns of Tosoh TSK-GELGMH6-HT

Dissolution conditions: 160° C., 2.5 hours

Calibration curve: A polystyrene conversion constant 0.48 was used for a polystyrene standard sample, and a cubic curve was used as an approximation.

(6) Observation of the Surface Structure of a Microporous Membrane

A specimen with suitable dimensions cut out of a microporous membrane was fixed on a specimen carrier by the use of an electroconductive, pressure-sensitive, adhesive double-coated tape and subjected to osmium plasma coating to a thickness of about 10 nm to obtain a specimen for microscopic examination. The surface structure of the microporous membrane was observed by the following ultrahigh-resolution scanning electron microscope (UHRSEM) at a predetermined magnification under conditions of an accelerating voltage of 1.0 kV and a photographing rate of 40 sec/frame:

Apparatus: ultrahigh-resolution scanning electron microscope Model S-900 manufactured by Hitachi Ltd.

(7) Observation of the Cross-Section Structure of a Microporous Membrane

A specimen with suitable dimensions cut out of a microporous membrane was subjected to pretreatment such as washing, freezing at liquid nitrogen temperature, and then severing to expose a section. The specimen was fixed on a specimen carrier and then subjected to osmium plasma coating to a thickness of about 10 nm to obtain a specimen for microscopic examination. The cross-section structure of the microporous membrane was observed at a predetermined magnification under conditions of an accelerating voltage of 1.0 kV and a photographing rate of 40 sec/frame by using the apparatus used in the above-mentioned observation of the surface structure.

(8) Analysis of a Porous Structure by Image Processing

A surface image photograph taken at a magnification of 10,000 to 30,000 in the above-mentioned observation of the surface structure was read with an image scanner to obtain an image having a quantity of information per unit area of the photograph of 2.6 kB/cm². Here, for a precise analysis of a porous structure, the quantity of information per unit area ranges preferably from 1 to 10 kB/cm². Then, said image was manually converted to binary data at a resolution per unit area of the photograph of 867 pixels/cm² by the use of an image processing system Model IP-1000PC manufactured by Asahi Kasei Kogyo K. K., to obtain a binary image, whereby the porous structure was analyzed. Here, for precisely analyzing the porous structure, the resolution per unit area ranges preferably from 500 to 2,000 pixels/cm². In the manual conversion to binary data, a threshold value was set in a valley in a color depth distribution composed of two peaks in said image, and the deep-color peak (space portions) and the pale-color peak (micro-fibril portions) were separated to obtain the binary image.

(9) Average Micro-Fibril Diameter

An area A (μm²) occupied by micro-fibrils in the above-mentioned binary image obtained from the surface image photograph of the microporous membrane using the above-mentioned image processing system was determined by an arithmetic processing. Then, the micro-fibril portions in the above-mentioned binary image were subjected to thinning, and the total length B (μm) of the micro-fibrils was determined. The average micro-fibril diameter L (nm) was calculated by the following expression of relation:
L=10³×A÷B

(10) Average Distance between Micro-Fibrils

Each micro-fibril space area si (nm²) and the number of spaces n in the above-mentioned binary image obtained from the surface image photograph of the microporous membrane by the use of the above-mentioned image processing system were determined by arithmetic processing. The diameter di (nm) in terms of a circle was calculated by the expressions of relation described below, by taking the circular constant as π. The average of values of the diameter dᵢ in terms of a circle was called the average distance D (nm) between micro-fibrils.
dᵢ=\sqrt{(4×sᵢ÷π)}
D=(Σdᵢ)÷n

(11) Micro-Fibril Space Density

The area E (μm²) of measurement region and the number n of micro-fibril spaces in the above-mentioned binary image obtained from the surface image photograph of the microporous membrane by the use of the above-mentioned image processing system were determined by arithmetic processing, and the micro-fibril space density X (spaces/μm²) was calculated by the following expression of relation:
x=n÷E

(12) Micro-Fibril Space Gradient

The above-mentioned binary image obtained from the surface image photograph of the microporous membrane by the use of the above-mentioned image processing system was divided into 20 equal parts in the direction of the thickness of the microporous membrane from the edge of one side of the microporous membrane to the edge of the other side, and each of the first and twentieth images thus obtained was called the surface layer and the second to nineteenth images were called the internal layer. Each micro-fibril space area sᵢ (nm²), the number of spaces n and the area E (μm²) of measurement region were determined by arithmetic processing, and the percentage Cⱼ (%) of an area occupied by micro-fibrils was calculated for each of the images obtained by the division, by the expressions of relation described below. Here, the ratio of the average value Cₛ of the occupied-area percentages C₁ and C₂₀ in the surface layer to the average value C_{I} of the occupied-area percentages C₂ to C₁₉ in the internal layer was calculated to determine the micro-fibril space gradient F.
Cⱼ=10⁻⁴×Σsᵢ×n÷E
Cₛ=(C₁+C₂₀)÷2
C_{I}=(C₂+C₃+ . . . +C₁₉)÷18
F=Cₛ÷C_{I}

(13) Thermally Induced Liquid-Liquid Phase Separation Point

Laboplastomill (Model 30C150) manufactured by Toyo Seiki Seisaku-sho Co., Ltd. and equipped with a twin screw (Model R100H) was used as a kneading apparatus. A composition prepared by mixing a polyethylene resin, a solvent, additives and the like in predetermined proportions, was fed into the Laboplastomill and melt-kneaded at a screw revolution of 50 rpm and at a predetermined temperature. In this case, although the kneading time may be freely chosen, it is preferably 5 to 10 minutes in view of the time required for the stabilization of the kneading torque, and the prevention of decomposition and deterioration of the resin. Then, the correlation between the kneading temperature (° C.) and the kneading torque (kg·m) was measured by setting the screw revolution at 10 rpm and air-cooling the kneaded composition by switching off a heater, while continuing the screw kneading, thereby obtaining a characteristic graph. In the characteristic graph, a temperature at which the kneading torque decreases rapidly with cooling was regarded as an inflection point due to liquid-liquid phase separation and was called a thermally induced liquid-liquid phase separation point (° C.).

(14) Relaxation Rate

For the dimensions of a microporous membrane before stretching, the relaxation rate (%) was defined by the following equation on the basis of the difference between a ratio set at the time of stretching and a ratio set at the time of heat treatment:

Relaxation rate=100×(ratio set at the time of stretching−ratio set at the time of heat treatment)

### REFERENCE EXAMPLE 1

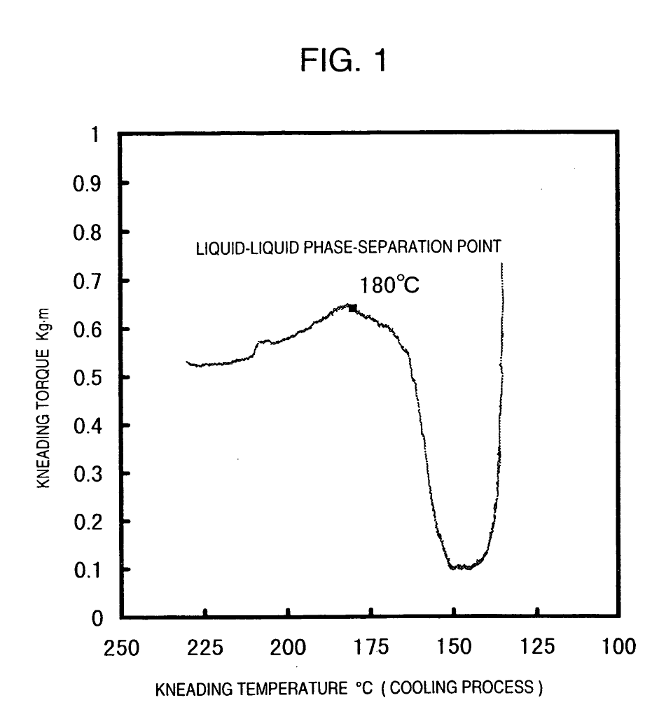

40 Parts by weight of a high-density polyethylene (weight average molecular weight 250,000, molecular weight distribution 7, density 0.956), 0.5 part by weight of 2,6-di-t-butyl-p-cresol and 60 parts by weight of di(2-ethylhexyl) phthalate were mixed and then fed into Laboplastomill. They were melt-kneaded for 5 minutes at a kneading temperature of 230° C. and at a screw revolution of 50 rpm, and the stabilization of the resin temperature and the kneading torque were awaited. Then, the change of the kneading torque with a lowered temperature was observed by setting the screw revolution at 10 rpm and air-cooling the kneaded composition from the original temperature of 230° C. by switching off a heater, while continuing the screw kneading, thereby evaluating a phase separation mechanism. From the characteristic graph shown in FIG. 1, it was found that said composition had a thermally induced liquid-liquid phase separation point of 180° C.

### REFERENCE EXAMPLE 2

A phase separation mechanism was evaluated by the same method as described in Reference Example 1, except for using 45 parts by weight of the same high-density polyethylene as described in Reference Example 1 and 55 parts by weight of di(2-ethylhexyl) phthalate. It was found that the resulting composition had a thermally induced liquid-liquid phase separation point of 168° C.

### REFERENCE EXAMPLE 3

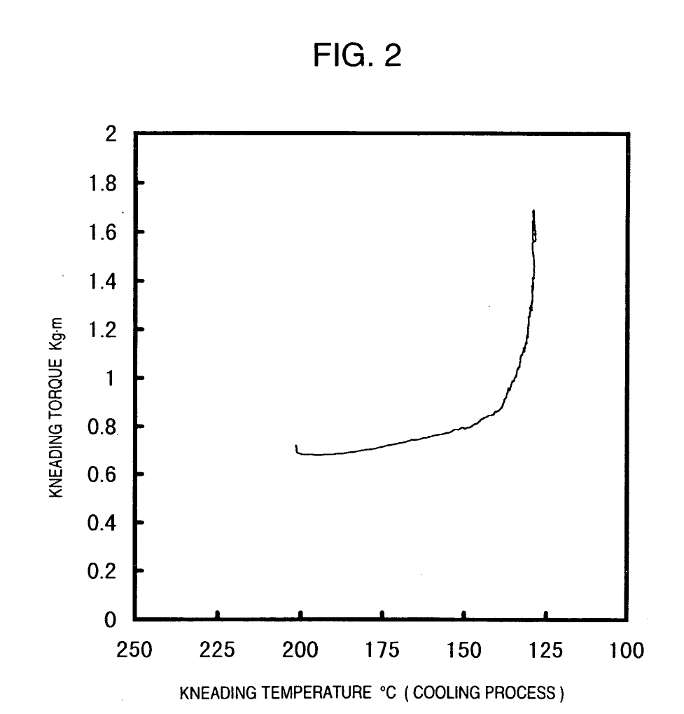

A phase separation mechanism was evaluated by the same method as described in Reference Example 1, except for using liquid paraffin (kinematic viscosity at 37.8° C.: 75.9 cSt) as a solvent and setting the kneading temperature and the original temperature at 200° C. From the characteristic graph shown in FIG. 2, it was found that the resulting composition had no thermally induced liquid-liquid phase separation point.

### REFERENCE EXAMPLE 4

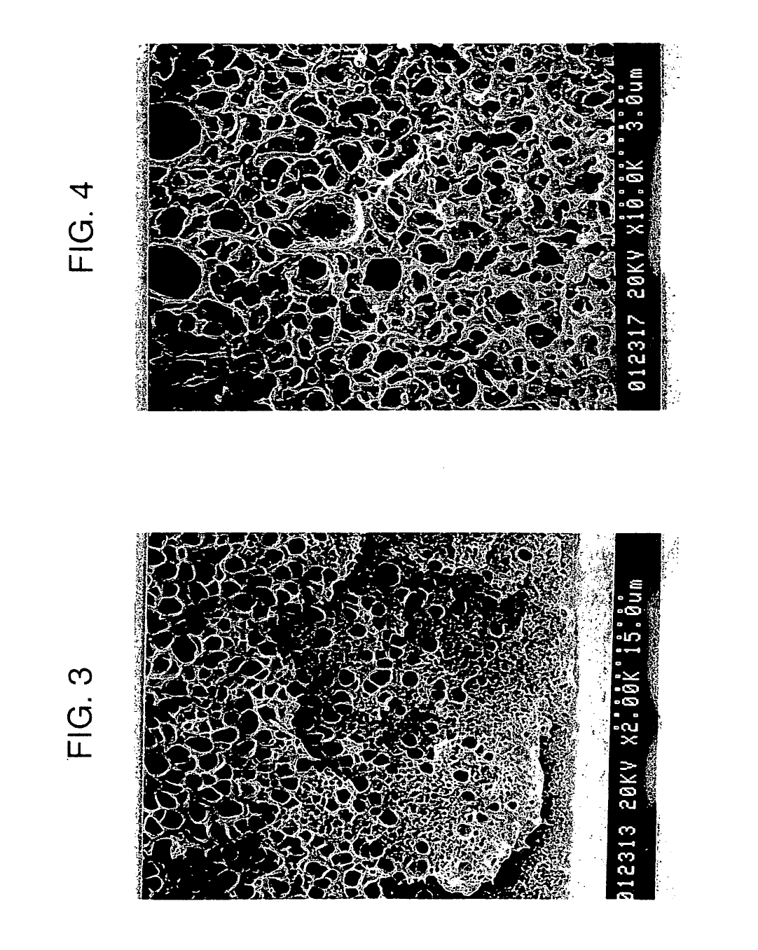

40 Parts by weight of the same high-density polyethylene as described in Reference Example 1, 0.5 part by weight of 2,6-di-t-butyl-p-cresol and 60 parts by weight of di(2-ethylhexyl) phthalate were mixed, fed into Laboplastomill, and then melt-kneaded for 5 minutes at a kneading temperature of 230° C. and a number of screw revolution of 100 rpm. Subsequently, the resulting kneaded composition was pressed into a sheet by the use of a compression molding machine heated at 230° C., and then dipped in water at 20° C. to be solidified by cooling at a cooling rate of 200° C./min, thus obtaining a sheet-like material of 1 mm in thickness. The sheet-like material was immersed in methylene chloride to extract and remove the di(2-ethylhexyl) phthalate, and then the adhering methylene chloride was removed by drying. The cross-section structure of the sheet thus obtained was observed by a scanning electron microscope (SEM). From the SEM photographs shown in FIG. 3 and FIG. 4, it can be seen that in the cross-section structure, a layer of about 18 μm in thickness composed of a percolation structure, is present near each surface layer of the sheet. In addition, the layer composed of a percolation structure was present near the surface layer on each side of the sheet, and relative to the whole section structure, the proportion of the layers composed of a percolation structure was 4% and the proportion of a layer composed of a cell structure was 96%.

### EXAMPLE 1

40 Parts by weight of a high-density polyethylene (weight average molecular weight 250,000, molecular weight distribution 7, density 0.956) and 0.3 part by weight of 2,6-di-t-butyl-p-cresol were dry blended in a Henschel mixer and fed into a 35-mm twin-screw extruder. Then, 60 parts by weight of di(2-ethylhexyl) phthalate was introduced into the extruder, followed by melt kneading at 230° C. The kneaded product was extrusion-casted onto a cooling roll controlled so as to have a surface temperature of 40° C., through a coat hanger die to obtain a sheet-like material of 1.8 mm in thickness. Subsequently, the sheet-like material was subjected to 7-fold×7-fold pre-extraction stretching by the use of a tenter simultaneous-biaxial-stretching machine and then immersed in 2-butanone to extract and remove the di(2-ethylhexyl) phthalate. Thereafter, the adhering 2-butanone was removed by drying, and the thus treated sheet-like material was subjected to 1.3-fold post-extraction stretching in the width direction with a tenter stretching machine to obtain a microporous membrane. As shown in Table 1, the obtained microporous membrane had a high penetration strength and a good permeability. The cross-section structure of a specimen obtained by extracting and removing the di(2-ethylhexyl) phthalate from said sheet-like material, was observed by a scanning electron microscope (SEM) to find that a layer of 90 μm in thickness composed of a percolation structure was present near the surface layer on each side of the sheet, and that relative to the whole section structure, the proportion of the layers composed of a percolation structure was 10% and the proportion of a layer composed of a cell structure 90%.

### EXAMPLE 2

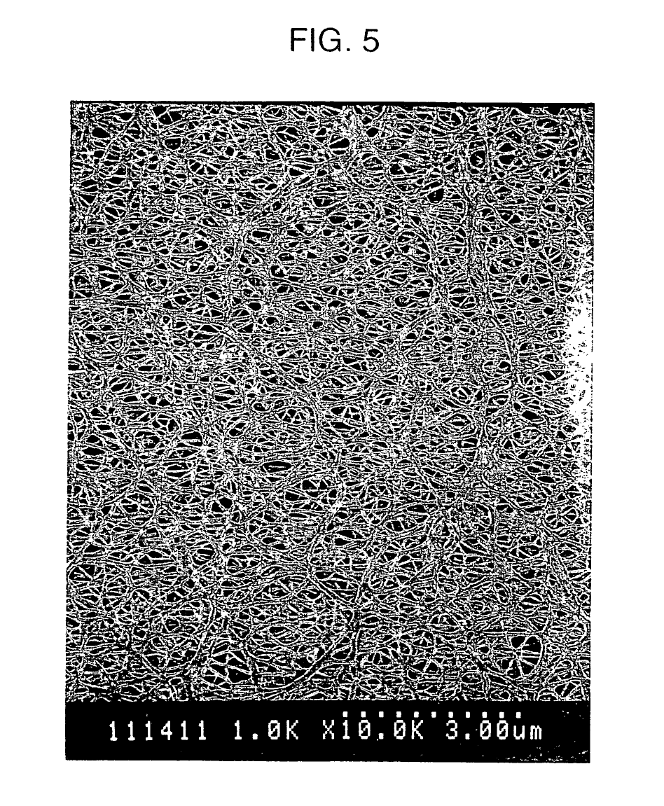

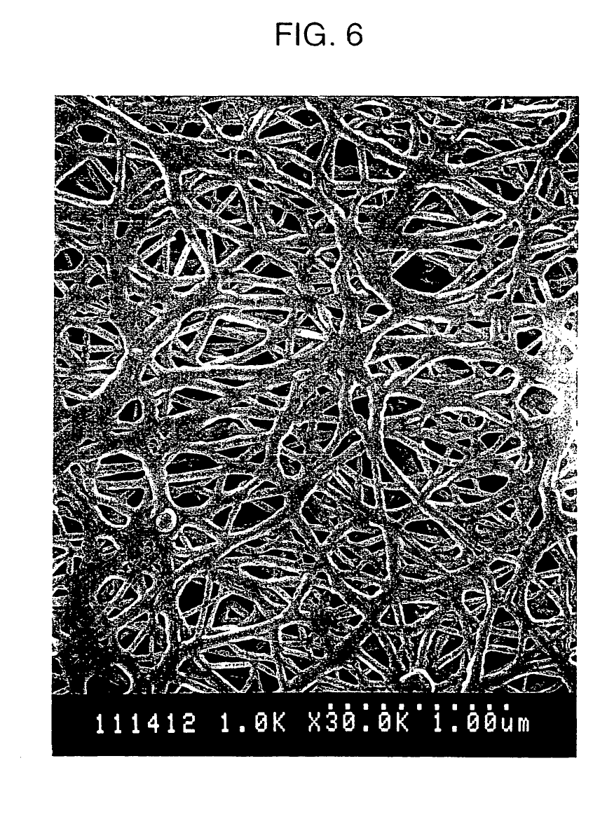

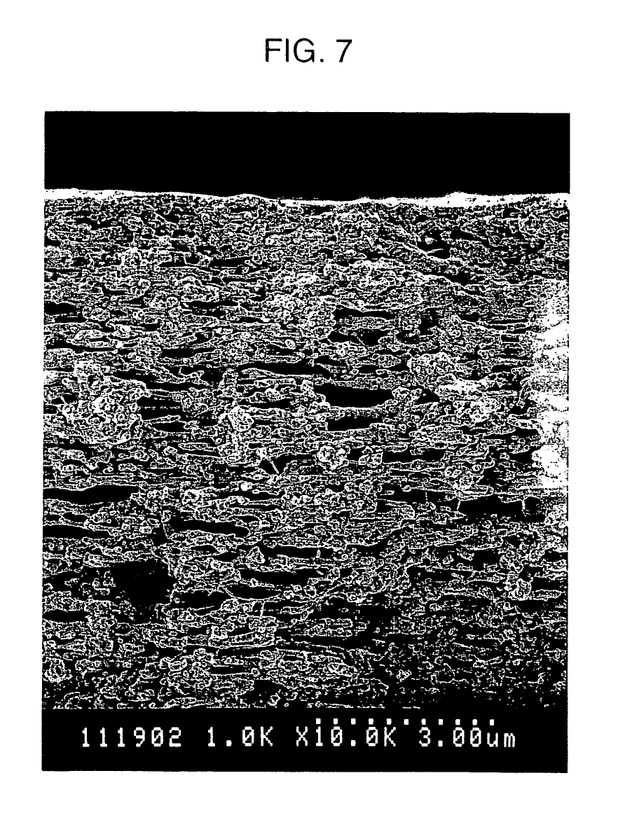

A microporous membrane was obtained in the same manner as in Example 1 except for changing the ratio of the post-extraction stretching in the width direction to 1.7-fold. As shown in Table 1, the obtained microporous membrane had a very high permeability without a decrease in its high penetration strength. FIG. 5 and FIG. 6 show the surface structure of the microporous membrane observed by a scanning electron microscope, and FIG. 7 shows the cross-section structure of the microporbus membrane observed by a scanning electron microscope. The obtained microporous membrane had a uniform porous structure comprising highly dispersed micro-fibrils, as its surface structure, and the internal layer portion was coarser than the surface layer portion.

### EXAMPLE 3

40 Parts by weight of the same high-density polyethylene as described in Example 1 and 0.3 part by weight of 2,6-di-t-butyl-p-cresol were dry blended in a Henschel mixer and fed into a 35-mm twin-screw extruder. Then, 60 parts by weight of di(2-ethylhexyl) phthalate was introduced into the extruder, followed by melt kneading at 230° C. The kneaded product was extrusion-casted onto a cooling roll controlled so as to have a surface temperature of 25° C., through a coat hanger die to obtain a sheet-like material of 1.8 mm in thickness. Subsequently, the sheet-like material was subjected to 7-fold×7-fold pre-extraction stretching by the use of a tenter simultaneous-biaxial-stretching machine and then immersed in methylene chloride to extract and remove the di(2-ethylhexyl) phthalate, after which the adhering methylene chloride was removed by drying. The treated sheet-like material was subjected to 1.8-fold post-extraction stretching in the width direction with a tenter stretching machine and then subjected to 50% thermal relaxation in the width direction to obtain a microporous membrane. As shown in Table 1, the obtained microporous membrane had a high penetration strength and a good permeability. The section structure of a specimen obtained by extracting and removing the di(2-ethylhexyl) phthalate from said sheet-like material was observed by a scanning electron microscope (SEM) to find that a layer of 100 μm in thickness composed of a percolation structure, was present near the surface layer on each side of the sheet and that, relative to the whole section structure, the proportion of the layers composed of a percolation structure, was 11% and the proportion of a layer composed of a cell structure 89%.

### EXAMPLE 4

A microporous membrane was obtained in the same manner as in Example 3 except for carrying out 10% thermal relaxation in the width direction. As shown in Table 1, the obtained microporous membrane had high penetration strength and good permeability.

### COMPARATIVE EXAMPLE 1

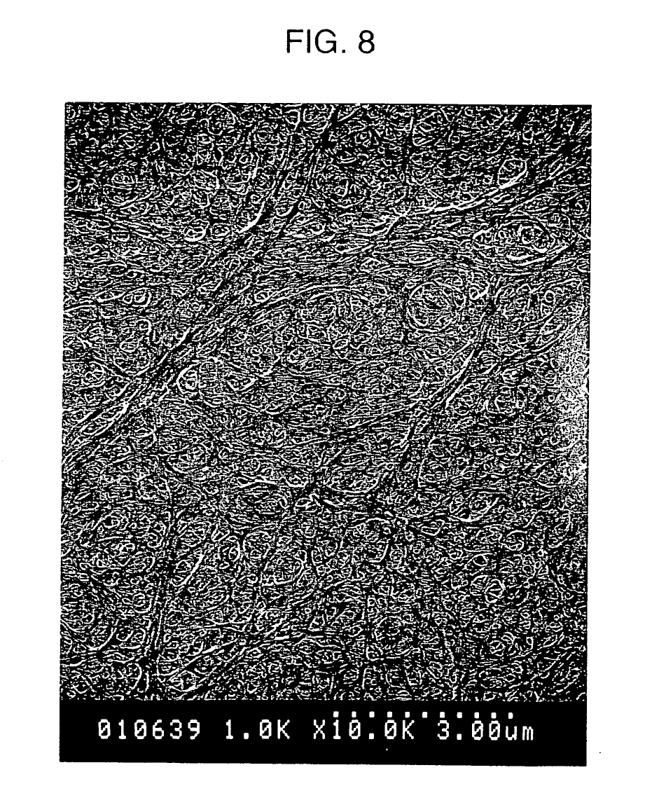

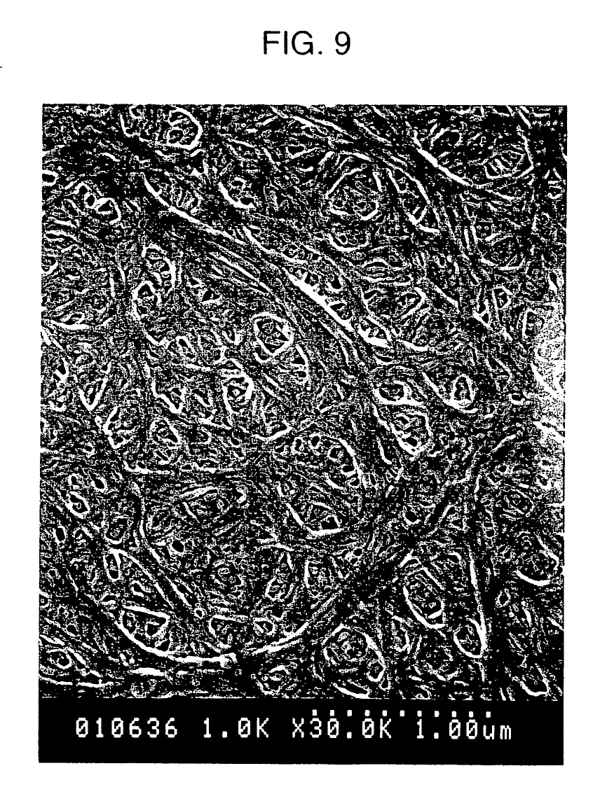

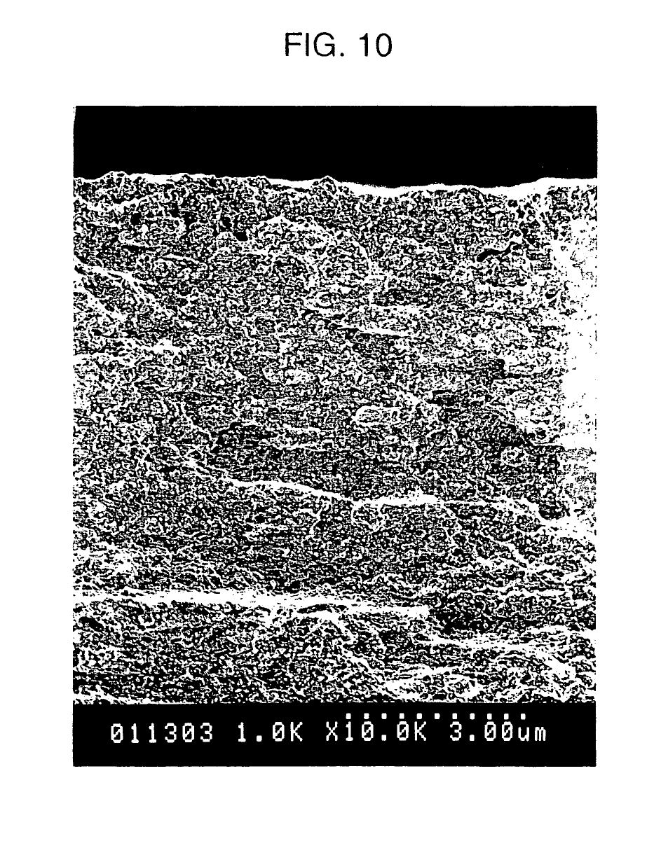

40 Parts by weight of the same high-density polyethylene as described in Example 1 and 0.3 part by weight of 2,6-di-t-butyl-p-cresol, were dry blended in a Henschel mixer and fed into a 35-mm twin-screw extruder. Then, 60 parts by weight of liquid paraffin (kinematic viscosity at 37.8° C.: 75.9 cSt) was introduced into the extruder, followed by melt kneading at 230° C. The kneaded product was extrusion-casted onto a cooling roll controlled so as to have a surface temperature of 40° C., through a coat hanger die to obtain a sheet-like material of 1.2 mm in thickness. Subsequently, the sheet-like material was subjected to 6-fold×6-fold pre-extraction stretching by the use of a test biaxial stretching machine and then immersed in 2-butanone to extract and remove the liquid paraffin, thereby obtaining a microporous membrane. As shown in Table 1, the obtained microporous membrane had a high penetration strength but was poor in permeability. FIG. 8 and FIG. 9 show the surface structure of the microporous membrane observed by a scanning electron microscope, and FIG. 10 shows the section structure of the microporous membrane observed by a scanning electron microscope. The surface structure and section structure of the obtained microporous membrane were very dense, indicating that such denseness of the structures inhibits the permeability.

### COMPARATIVE EXAMPLE 2

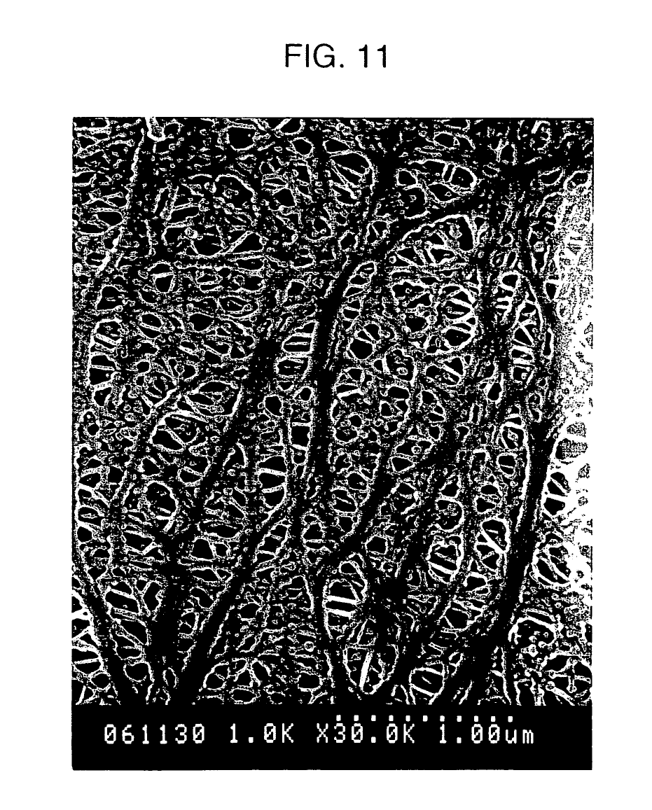

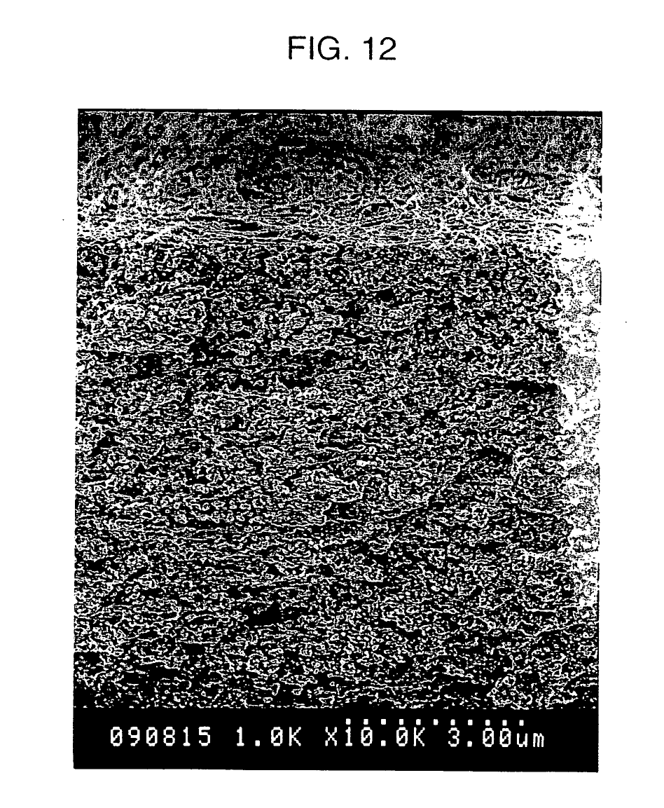

The sheet-like material obtained in Comparative Example 1 was subjected to 5-fold×5-fold pre-extraction stretching by the use of a test biaxial stretching machine and then immersed in 2-butanone to extract and remove the liquid paraffin, followed by 2.0-fold post-extraction stretching in the width direction by the use of a test biaxial stretching machine, whereby a microporous membrane was obtained. As shown in Table 1, the obtained microporous membrane had a better permeability but had a much lower penetration strength than did the microporous membrane obtained in Comparative Example 1. FIG. 11 shows the surface structure of the microporous membrane observed by a scanning electron microscope, and FIG. 12 shows the cross-section structure of the microporous membrane observed by a scanning electron microscope. In the surface structure of the obtained microporous membrane, the dispersion of micro-fibrils was not sufficient and a large number of fibrils adhering to one another are present, and there was observed the short distance between micro-fibrils without a sufficient increase in the distance. The distance between micro-fibrils observed in the section structure was uniform in the whole section structure, and such a gradient structure as observed in the microporous membrane of the present invention was not observed.

### COMPARATIVE EXAMPLE 3

The sheet-like material described in Example 3 was immersed in methylene chloride to extract and remove the di(2-ethylhexyl) phthalate, after which the adhering methylene chloride was removed by drying, and the treated sheet-like material was subjected to post-extraction stretching with a test biaxial stretching machine to obtain a microporous membrane. As shown in Table 2, the obtained microporous membrane had an excessively increased porosity due to the stretching and hence had a low penetration strength.

### COMPARATIVE EXAMPLE 4

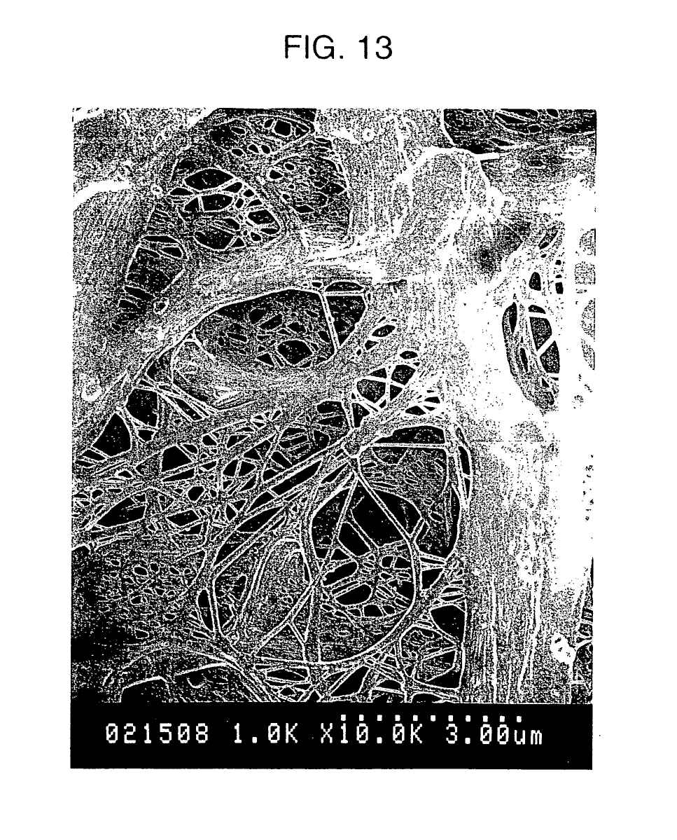

45 Parts by weight of the same high-density polyethylene as described in Example 1 and 0.3 part by weight of 2,6-di-t-butyl-p-cresol were dry blended in a Henschel mixer and fed into a 35-mm twin-screw extruder. Then, 55 parts by weight of di(2-ethylhexyl) phthalate were introduced into the extruder, followed by melt kneading at 230° C. The kneaded product was extrusion-casted onto a cooling roll controlled so as to have a surface temperature of 120° C., through a coat hanger die to obtain a sheet-like material of 1.3 mm in thickness. The obtained sheet-like material was immersed in methylene chloride to extract and remove the di(2-ethylhexyl) phthalate, and then the adhering methylene chloride was removed by drying. Subsequently, the thus treated sheet-like material was subjected to post-extraction stretching with a test biaxial stretching machine to obtain a microporous membrane. As shown in Table 2, the obtained microporous membrane had an excessively increased porosity due to the stretching and hence had a low penetration strength. FIG. 13 shows the surface structure of the microporous membrane observed by a scanning electron microscope. In the surface structure of the obtained microporous membrane, there were observed the insufficient dispersion of micro-fibrils and thick trunk-like macro-fibrils forming the basic skeleton of the structure. The cross-section structure of a specimen obtained by extracting and removing the di(2-ethylhexyl) phthalate from said sheet-like material, was observed by a scanning electron microscope to find that the section structure of the specimen did not contain a layer composed of a percolation structure but is composed of a layer composed of a cell structure.

TABLE 1

| | | | | | Comparative | Comparative |
|---|---|---|---|---|---|---|
| | Example 1 | Example 2 | Example 3 | Example 4 | Example 1 | Example 2 |
| Mode for pre-extraction | Simultaneously | Simultaneously | Simultaneously | Simultaneously | Simultaneously | Simultaneously |
| stretching | biaxial | biaxial | biaxial | biaxial | biaxial | biaxial |
| Draw ratio (-fold) | 7 × 7 | 7 × 7 | 7 × 7 | 7 × 7 | 6 × 6 | 5 × 5 |
| Stretching temp.(° C.) | 125 | 125 | 128 | 128 | 120 | 120 |
| Mode for post-extraction | Uniaxial in | Uniaxial in | Uniaxial in | Uniaxial in | No stretching | Uniaxial in |
| stretching | the width | the width | the width | the width | | the width |
| | direction | direction | direction | direction | | direction |
| Draw ratio (-fold) | 1.3 | 1.7 | 1.8 | 1.8 | | 2.0 |
| Stretching temp.(° C.) | 125 | 125 | 125 | 125 | | 125 |
| Mode for heat treatment | No heat | No heat | Thermal | Thermal | No heat | No heat |
| | treatment | treatment | relaxation | relaxation | treatment | treatment |
| Relaxation rate (%) | | | 50 | 10 | | |
| Heat treatment temp.(° C.) | | | 130 | 130 | | |
| Membrane thickness (μm) | 27 | 25 | 28 | 26 | 33 | 25 |
| Porosity (%) | 48 | 55 | 49 | 60 | 48 | 65 |
| Air permeability (sec/25 μm) | 160 | 100 | 149 | 94 | 500 | 90 |
| Penetration strength | 590 | 480 | 605 | 469 | 580 | 250 |
| (gf/25 μm) | | | | | | |
| Micro-fibril space density | 34 | 48 | 45 | 50 | 45 | 73 |
| (spaces/μm²) | | | | | | |
| Average micro-fibril | 56 | 46 | 48 | 43 | 65 | 65 |
| diameter (nm) | | | | | | |
| Average distance between | 52 | 56 | 53 | 62 | 23 | 33 |
| micro-fibrils (nm) | | | | | | |
| Micro-fibril space gradient | 0.55 | 0.60 | 0.53 | 0.58 | 1.20 | 1.30 |

TABLE 2

| | Comparative | Comparative |
|---|---|---|
| | Example 3 | Example 4 |
| Mode for post-extraction | Simultaneously | Simultaneously |
| stretching | biaxial | biaxial |
| Draw ratio (-fold) | 4 × 4 | 4 × 4 |
| Stretching temp.(° C.) | 130 | 120 |
| Membrane thickness (μm) | 141 | 133 |
| Porosity (%) | 73 | 75 |
| Air permeability (sec/25 μm) | 19 | 7 |
| Penetration strength | 240 | 214 |
| (gf/25 μm) | | |
| Micro-fibril space density | 5 | 6 |
| (spaces/μm²) | | |
| Average micro-fibril diameter | 120 | 161 |
| (nm) | | |
| Average distance between | 150 | 118 |
| micro-fibrils (nm) | | |

### INDUSTRIAL APPLICABILITY

The microporous membrane of the present invention has a surface structure comprising highly dispersed micro-fibrils and hence is free from local nonuniformity of its permeability. Furthermore, since the surface structure comprises a network with a high stiffness comprising highly oriented micro-fibrils, the microporous membrane can have both high membrane strength and good permeability. Therefore, the microporous membrane is especially useful as a separator for battery.

What is claimed is:

1. A process for producing a polyolefin microporous membrane, comprising:
(a) a step of melt-kneading a composition consisting of a polyolefin resin and a solvent which has a thermally induced liquid-liquid phase-separation point when mixed with said polyolefin resin, to effect uniform dispersion, and then solidifying the resulting dispersion by coding to form a sheet-like material comprising layers composed of a percolation structure and a layer composed of a cell structure;
(b) a step of conducting at least one run of stretching at least uniaxially after the above step (a);
(c) a step of removing a substantial portion of the aforesaid solvent after the above step (b); and
(d) a step of conducting at least one run of stretching at least uniaxially after the above step (c).

2. The process according to claim 1, wherein the polyolefin resin is a polyethylene resin.

3. The process according to claim 1, wherein the stretching at step (b) is conducted at a draw ratio of 4 to 20.

4. The process according to claim 1, wherein the stretching at step (b) is conducted by biaxial stretching.
